(19) United States
(12) Patent Application Publication
(10) Pub. No.: US 2012/0330678 A1
(43) Pub. Date: Dec. 27, 2012

(54) System and Method for Targeted Healthcare Messaging Using Mobile Communication Devices

(76) Inventors: Paul Kobylevsky, Flushing, NY (US); Valery Gurovich, Ramsey, NJ (US)

(21) Appl. No.: 13/540,780

(22) Filed: Jul. 3, 2012

Related U.S. Application Data
(63) Continuation-in-part of application No. 12/058,931, filed on Mar. 31, 2008.
Application No. 12/058,931 is a continuation-in-part of application No. 11/711,496, filed on Feb. 27, 2007.

(51) Int. Cl. G06Q 50/22

(52) U.S. Cl. 705/2

(57) ABSTRACT

Systems and methods are provided for targeted healthcare messaging using mobile communication devices. A targeted messaging server is provided and is in communication with a plurality of data sources and a mobile communication device remote from the targeted messaging system. The system detects prescription-related activity occurring at the mobile communication device and automatically generates a request for a targeted healthcare message in response to a prescription-related activity detected by the system. The targeted messaging server receives the request, queries a database to identify a link to a matching targeted healthcare message, and transmits the link to the mobile communication device. The link is accessed at the mobile communication device and to convey the targeted healthcare message to the user.

### RELATED APPLICATIONS

This application is a continuation-in-part of U.S. patent application Ser. No. 12/058,931 filed Mar. 31, 2008, now U.S. Pat. No. ______, which is a continuation-in-part of U.S. patent application Ser. No. 11/711,496 filed Feb. 27, 2007, now U.S. Patent No. ______, the entire disclosures of which are all expressly incorporated herein by reference.

### BACKGROUND OF THE INVENTION

1. Field of the Invention

The present invention relates to computer systems for automatically delivering targeted messages to recipients using mobile communication devices. More specifically, the present invention relates to a system and method for automatically delivering targeted healthcare messages to recipients such as patients, prescribers, pharmacy staff, and other individuals involved in the selection and use of pharmaceuticals and other health care products.

2. Related Art

Electronic advertising systems are well-known in the art. Such systems allow targeted advertisements and messages to be sent to specific recipients, so as to maximize the likelihood that the recipient will purchase advertised goods or services, participate in a requested activity, or provide requested information. Such systems may be operated in connection with interactive voice response (IVR) systems, wherein a targeted advertisement or message is played to a caller. Other systems are operated in connection with Internet web pages, wherein user statistics are tracked by web sites, targeted advertisements or messages are generated based upon the statistics, and the targeted advertisements or messages are transmitted to the user's web browser for display to the user. Still further, various types of targeted electronic mail (e-mail) advertisement systems are known in the art.

It is also known in the art to provide targeted messages to a caller of an IVR-based prescription system. In such systems, a caller dials a telephone number and is provided with information about a particular type of prescription, or other information relating to pharmaceuticals. Additionally, educational information can be provided to the caller.

A particular drawback with existing targeted messaging systems is that they do not provide a central (or universal) system wherein targeted advertisements and messages generated by a plurality of data sources, such as a plurality of pharmaceutical companies, can be centrally gathered and incoming requests for targeted messages can be processed over the Internet. Additionally, such systems do not allow targeted messages to be sent to a plurality of recipients so that targeted messages can be conveyed to recipients in multiple formats, such as by physical mailing, in IVR telephone calls, by electronically transmitting targeted messages to one or more pharmacy computer systems for use thereby, by printing advertisements at pharmacy points-of-sale, in web-based prescription refill applications, in electronic prescription and/or transcription sessions, and by facsimile. As such, the reach of existing systems to a multitude of recipients, each using various communications formats, is limited.

Accordingly, what would be desirable, but has not yet been provided, is a system and method for targeted healthcare messaging which addresses the foregoing limitations of existing messaging systems.

### SUMMARY OF THE INVENTION

The present invention relates to a system and method for targeted healthcare messaging. The system includes a central targeted messaging server for receiving targeted advertisements or messages from a plurality of data sources, such as a plurality of pharmaceutical companies, and assigning one or more pre-defined criteria to each message; a notification database for storing the targeted messages and the pre-defined criteria; and a web server which can communicate with a plurality of message requesters to receive requests for targeted messages and to convey same to the plurality of message requesters. A “self-service” web application could be provided by the system, wherein a vendor (e.g., a pharmaceutical company, etc.) can upload a customized targeted message file and/or an associated voice file to the system using a conventional web browser. The notification database is populated by the uploaded targeted message files and/or voice files, and pre-defined criteria are associated with the uploaded targeted message file and/or voice files and stored in the notification database.

In response to a prescription-related activity (such as a patient requesting a prescription refill (in person or electronically), a doctor prescribing a drug (electronically or otherwise), a pharmacist refilling a prescription, authorization of a prescription refill by a doctor, or other prescription-related activity), a request for a targeted message is generated and transmitted to the system of the present invention. Incoming requests may be received by the system of the present invention as hypertext transfer protocol (HTTP), extensible markup language (XML), and/or simple object access protocol (SOAP) requests for targeted messages. The requests contain one or more pre-defined criteria such as patient age, patient gender, National Drug Council (NDC) drug code, original fill date for a prescription, number of refills remaining, quantity remaining, days of supply on last refill, and other information. The targeted messaging server queries the notification database using the pre-defined criteria to identify a matching targeted message. The matching targeted message is then transmitted to the recipient in a suitable format, such as in a text file and/or a voice file, and conveyed to the recipient. The recipient can transmit a message delivery receipt to the targeted messaging server and the targeted messaging server can reply with a delivery confirmation response, so as to confirm receipt of the targeted message to the recipient. The system of the present invention allows targeted messages to be electronically transmitted to recipients in multiple formats, such as by physical mail, electronic mail, audibly in an IVR prescription refill telephone call, printed at a point of sale, audibly in an electronic prescription or transcription session, or by facsimile, etc. Additionally, the present invention allows targeted messages requesting participation in clinical trials to be electronically transmitted to recipients.

In another embodiment, the present invention relates to a system for targeted healthcare messaging using mobile communication devices. The system includes a targeted messaging server in communication with a plurality of data sources and a mobile communication device remote from the targeted messaging system; a database in communication with the targeted messaging system and storing a plurality of targeted healthcare messages; and a targeted messaging application executed by the mobile communication device, the targeted messaging application detecting an occurrence of a prescription-related activity occurring at the mobile communication device, generating a request for a targeted healthcare message in response to detection of the prescription-related, and transmitting the request to the targeted messaging server. The targeted messaging server receives the request, identifies a link corresponding to a matching targeted message, and transmits the link to the mobile communication device, and the link is accessed by the mobile communication device to convey the matching targeted message to the user.

The present invention also provides a method for targeted healthcare messaging using a mobile communication device. The method includes the steps of detecting a prescription-related activity occurring at a mobile communication device; generating a request for a targeted healthcare message at the mobile communication device; transmitting the request to a targeted messaging server remote from the mobile communication device; receiving the request at the targeted messaging server; querying a database to identify a link corresponding to a matching targeted healthcare message; transmitting the link to the mobile communication device; accessing the link at the mobile communication device; and conveying the targeted healthcare message to the user at the mobile communication device.

### BRIEF DESCRIPTION OF THE DRAWINGS

The foregoing features of the invention will be apparent from the following Detailed Description of the Invention, taken in connection with the accompanying drawings, in which:

FIG. 1 is a block diagram showing the targeted healthcare messaging system of the present invention;

FIG. 2 is a block diagram showing transaction processing implemented by the targeted healthcare messaging system of FIG. 1;

FIG. 3 is a flowchart showing processing logic of the targeted healthcare messaging system of the present invention;

FIG. 4 is a flowchart showing steps for mailing a targeted healthcare message generated by the present invention to a recipient;

FIG. 5 is a flowchart showing steps for providing a targeted healthcare message generated by the present invention to a pharmacy management computer system;

FIG. 6 is a flowchart showing steps for providing an audible targeted healthcare message generated by the present invention during a telephonic prescription refill request;

FIG. 7 is a flowchart showing steps for providing a targeted healthcare message generated by the present invention to a recipient at a pharmacy point of sale;

FIG. 8 is a flowchart showing steps for providing a targeted healthcare message generated by the present invention in a web-based prescription refill request;

FIG. 9 is a flowchart showing steps for providing a targeted healthcare message generated by the present invention in an electronic prescription and/or transcription session;

FIG. 10 is a flowchart showing processing steps for faxing a targeted healthcare message generated by the present invention to a recipient;

FIG. 11 is a diagram showing another embodiment of the targeted healthcare messaging system of the present invention, wherein targeted pharmaceutical messages are delivered using mobile communication devices; and

FIG. 12 is a flowchart showing processing steps carried out by the targeted healthcare messaging system shown in FIG. 11.

### DETAILED DESCRIPTION OF THE INVENTION

The present invention relates to a system and method for targeted healthcare messaging which includes a central targeted messaging server for receiving targeted advertisements or messages from a plurality of data sources, a notification database for storing the targeted messages and associated, pre-defined criteria, and a web server which can communicate with a plurality of message requesters to receive requests for targeted messages and to convey same to the plurality of message requesters. A customized web site could be provided for allowing vendors (e.g., pharmaceutical companies, etc.) to upload targeted message text files and/or voice files to the system of the present invention. In response to prescription-related activity, requests for targeted messages are transmitted by the plurality of message requesters to the system of the present invention. Incoming requests are received by the system of the present invention and contain one or more pre-defined criteria. The targeted messaging server queries the targeted message database using the pre-defined criteria to identify a matching targeted message. The matching targeted message is then transmitted to the recipient in a suitable format, such as in a text file and/or a voice file, and conveyed to the recipient.

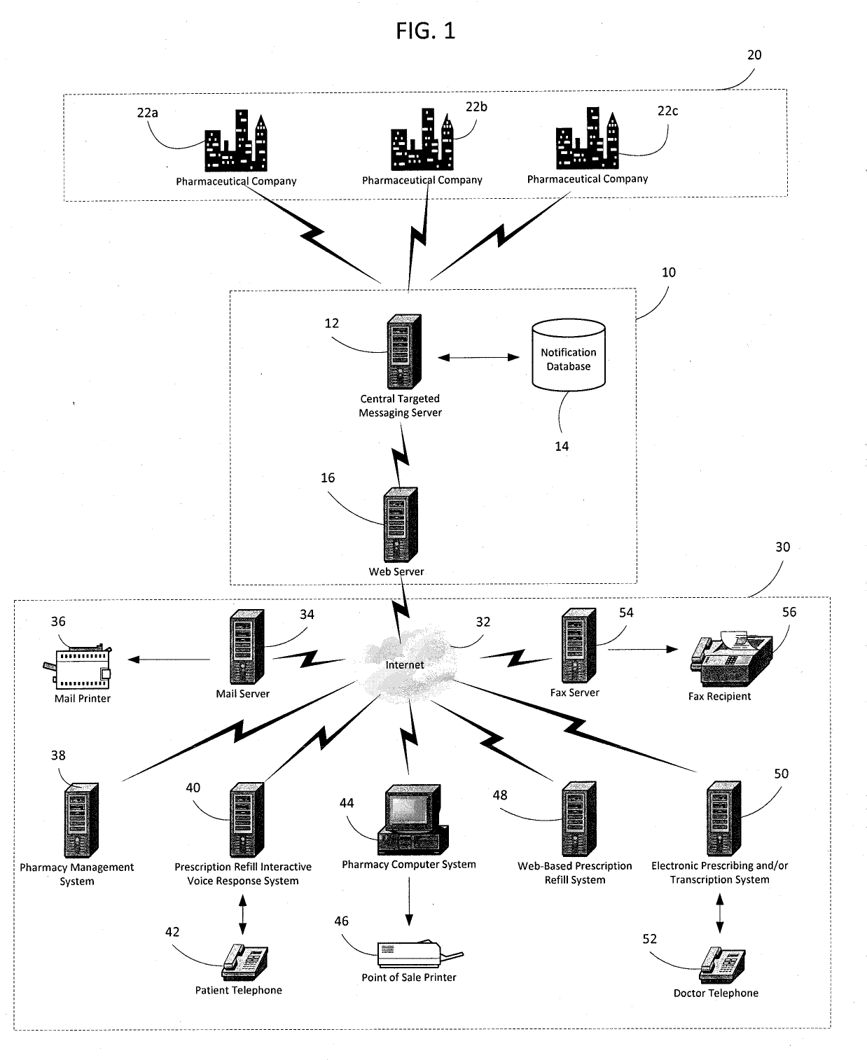

FIG. 1 is a block diagram showing the targeted healthcare or pharmaceutical messaging system (hereinafter, “TPMS” or “notification web service”) of the present invention, indicated generally at 10. The TPMS 10 includes a central targeted messaging server 12, a notification database 14, and a web server 16. The central targeted messaging server 12 communicates with a plurality of data sources 20, such as pharmaceutical companies 22a-22c, to obtain targeted messages relating to pharmaceutical products. Such messages could be electronically transmitted between the data sources 20 and the central targeted messaging server 12 (e.g., over the Internet or through a private network connection, such as a wide-area network (WAN) connection, as e-mails, electronic data interchange (EDI) messages, extensible markup language (XML) messages, file transfer protocol (FTP) file transfers, etc., or any other suitable electronic communications format). Other forms of communication between the data sources 20 and the TPMS 10 are possible, such as by physical mailing or facsimile transmission of targeted messages by the data sources 20 to the TPMS 10. In such circumstances, the messages would be converted by the TPMS 10 into electronic format for storage therein. Importantly, the TPMS 10 can be configured to receive targeted healthcare messages. A customized; “self-service” web site could be provided by the TPMS 10, wherein one or more of the data sources 20 can upload targeted message text and/or voice files to the TMPS 10. Such a web site could be accessed by the data sources 20 using conventional web browsers. User accounts could be provided, such that each data source 20 could selectively log onto the TPMS 10 to modify existing messages, delete messages, upload new messages, and change parameters associated with each message.

The central targeted messaging server 12 stores targeted healthcare messages in the notification database 14. Each message is assigned a pre-defined criteria by the central targeted messaging server 12, or by the data sources 20, so that appropriate messages can be retrieved from the notification database 14 in response to a request for a targeted message. Each targeted message and its associated pre-defined criteria are stored in the notification database 14.

The web server 16 of the TPMS 10 of the present invention can communicate with a plurality of message requesters 30 to receive requests for targeted healthcare messages, transmit such requests to the messaging server 12, receive appropriate targeted messages from the messaging server 12, and transmit the targeted healthcare messages to the plurality of message requesters 30. Communication between the web server 16 and the message requesters 30 is preferably by way of the Internet 32, using standard TCP/IP communications protocols such as hypertext transfer protocol (HTTP), secure HTTP (HTTPS), file transfer protocol (FTP), and other suitable protocols such as electronic data interchange (EDI). It is conceivable that the

TPMS 10 could also be configured to communicate with the message requesters 30 using other types of communications media, such as wireless communications (e.g., across one or more cellular telephone networks, pager networks, short messaging service (SMS) communications, etc.) or any other suitable types of wireless or wired communications media. The message requesters 30 generate requests for targeted messages whenever prescription-related activity occurs. Examples of such activities include, but are not limited to, a prescription refill request by a patient (electronically or otherwise), a doctor creating a new prescription, a doctor authorizing a prescription refill request, a pharmacist re-filling a prescription, and other prescription-related activities.

Importantly, the TPMS 10 can receive requests for targeted healthcare messages, and can deliver such messages, in a variety of formats and across a wide variety of end-user platforms. For example, the plurality of messages requesters 30 could include, but is not limited to, a mail server 34 and an associated mail printer 36, a pharmacy management system 38, a prescription refill interactive voice response system 40 (which allows for telephone communication with a patient using the patient's telephone 42), a pharmacy computer system 44 and an associated printer 46, a web-based prescription refill system 48, an electronic prescribing and/or electronic transcription system 50 (which allows for telephone communication with a doctor using the doctor's telephone 52, or using a doctor's computer system connected to the system 50 via the Internet), or a facsimile (fax) server 54 for allowing faxes to be sent to a fax recipient 56.

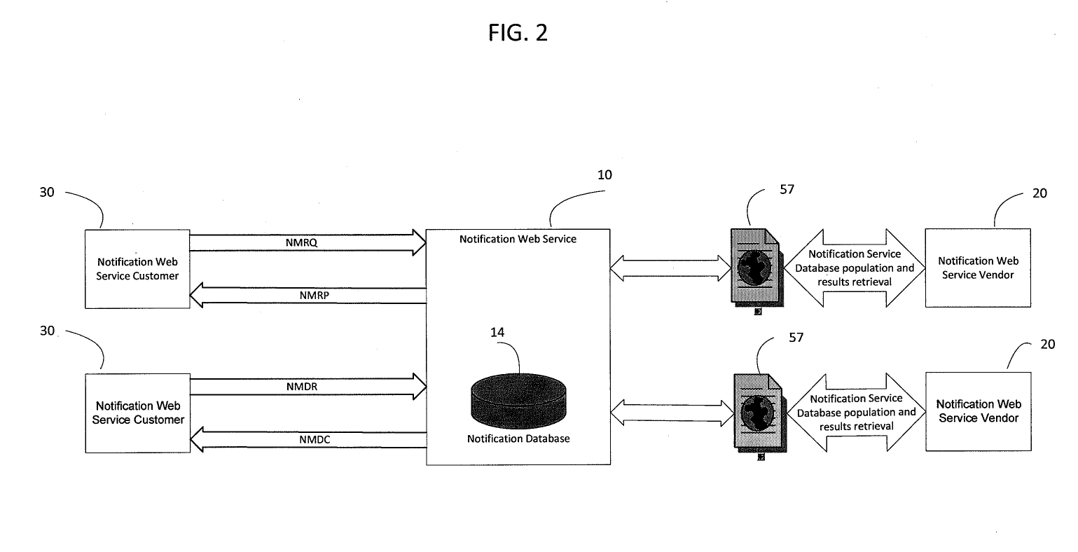

FIG. 2 is a block diagram showing transaction processing implemented by the TPMS 10 of the present invention. The TPMS 10 (also referred to in FIG. 2 as the notification web service) can provide a customized, “self-service” web site for allowing the data sources 20 (also referred to in FIG. 2 as notification web service vendors) to upload targeted message text and/or voice files to the TPMS 10. Such a web site could be presented to the data sources 20 using one or more secure web pages 57. Each data source 20 could be provided with a user account wherein targeted messages can be managed, edited, added, deleted, and attributes thereof modified as desired. One or more pre-defined criteria can be defined by the data sources 20, and associated with a particular targeted message.

The TPMS 10 populates the notification database 14 with the targeted message text and/or voice files, as well as the pre-defined criteria associated with each file. Examples of the pre-defined criteria could include, but are not limited to: message identifier; vendor identifier; drug item name; National Drug Council (NDC) identifier; therapeutic class; manufacturer; last fill dates (including minimum and/or maximum values); first fill dates (including minimum and/or maximum values); days of supply (including minimum and/or maximum values); original refill numbers (including minimum and/or maximum values); remaining refills (including minimum and/or maximum values); patient age (including minimum and/or maximum values); patient gender; patient diagnosis; patient disease state; text file identifier; voice file identifier; file location identifiers; update dates; and/or update identifiers. The locations of uploaded text and/or voice files can be stored as Uniform Resource Locator (URL) addresses, or in any other suitable format. It should also be noted that information relating to vendors (e.g., one or more of the data sources 20) and customers (e.g., one or more of the plurality of message requesters 30 of FIG. 1) could be associated with particular targeted messages and the notification database 14 populated with such information. Examples include, but are not limited to: vendor identifiers; vendor mailing address information; vendor phone information; vendor e-mails; vendor types; vendor account and password information; customer identifiers; customer mailing address information; customer phone information; customer e-mails; customer types; customer account and password information. Also, message logs could be created and stored in the notification database 14 to facilitate administration of transaction activities and user accounts.

In response to a prescription-related activity, one or more of the plurality of message requesters 30 (referred to in FIG. 2 as notification web service customers) generates a request for a targeted message in the form of a notification message request (NMRQ), and transmits the NMRQ to the TPMS 10. The NMRQ could be formatted and transmitted as a conventional Simple Object Access Protocol (SOAP) request (as defined in the SOAP 1.2 W3C specification, located on the Internet at http://www.w3.org/TR/soap/), or in any other suitable format. The NMRQ could include, but is not limited to, the following fields of information: customer identifier; NDC number; last fill date; first fill date; days of supply remaining in current prescription; number of original refills authorized; refills remaining; patient age; patient gender; patient diagnosis; and/or patient disease state.

Upon receipt of the NMRQ, the TPMS 10 utilizes one or more of the fields of the NMRQ to retrieve a matching targeted message from the notification database 14. When a matching targeted message record is found, a notification message response (NMRP) is created by the TPMS 10 and transmitted to the message requester 30 in the form of a SOAP response. It should be noted that any other suitable message format could be used. The NMRP includes, but is not limited to, the following fields of information: customer identifier; message identifier; message retrieval transaction identifier; message retrieval result; and message file location.

When the NMRP is received by the message requester 30, a notification message delivery receipt (NMDR) is sent by the message requester 30 to the TPMS 10. The NMDR could be a SOAP request (or other suitable format) which includes, but is not limited to, the following fields of information: customer identifier; message identifier; message retrieval transaction identifier; and message delivery result. In response to the NMDR, the TPMS 10 generates a notification message delivery confirmation (NMDC), which is sent to the message requester 30 as final confirmation of the transaction. The NMDC could be a SOAP reply (or other suitable format), which includes, but is not limited to, the following fields of information: message delivered indication; message delivery failure indication; or message delivery declined indication.

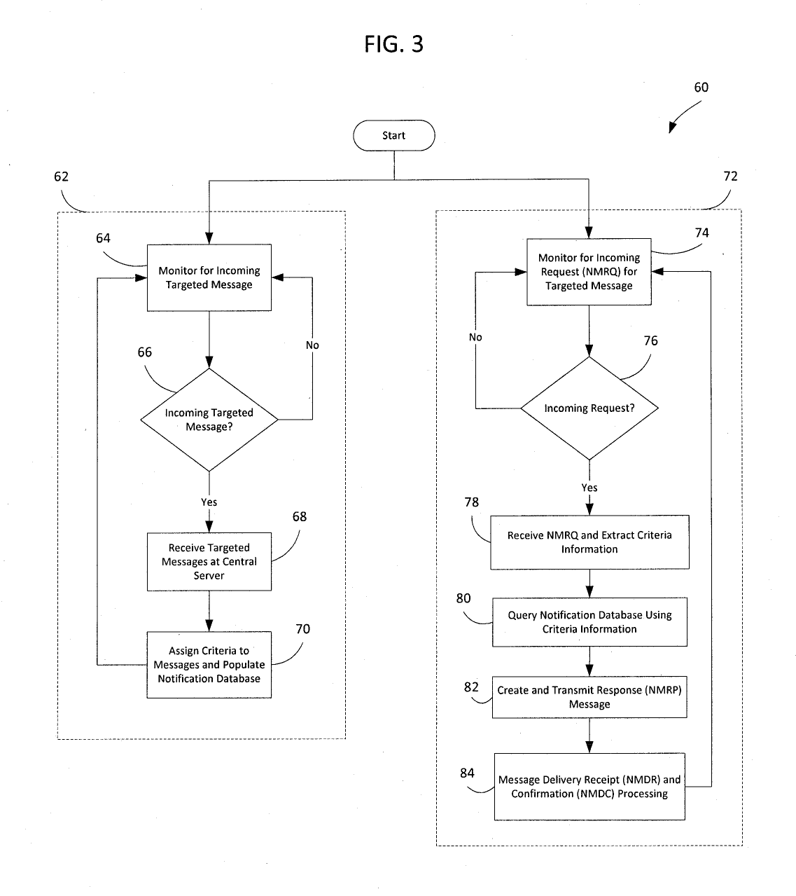

FIG. 3 is a flowchart, indicated generally at 60, showing processing logic of the TPMS 10 of the present invention. As mentioned above, the TPMS 10 stores targeted healthcare messages from a plurality of data sources (e.g., pharmaceutical companies), processes requests for targeted healthcare messages, and delivers targeted healthcare messages to recipients in a plurality of formats and across a variety of hardware platforms. The TPMS 10 processes incoming targeted messages from one or more data sources in a message handling process 62, and incoming requests for targeted messages are processed in a request handling process 72.

The message handling process 62 begins with monitoring step 64, wherein the TPMS 10 monitors for incoming targeted messages that are provided to the TPMS 10 from a data source, such as the pharmaceutical companies 22a-22c of FIG. 1. In step 66, a determination is made as to whether an incoming targeted message has been received by the TPMS 10. If a negative determination is made, step 64 is repeated. If a positive determination is made, step 68 occurs, wherein one or more targeted messages are received at the TPMS 10. Then, in step 70, one or more of the aforementioned pre-defined criteria are assigned to each message. Then, the notification database 14 (see FIGS. 1-2) of the TPMS 10 is populated with the one or more targeted messages after the criteria have been assigned. Then, steps 64-70 are repeated so that additional incoming messages can be monitored for and processed.

The targeted message request handling process 72 begins with step 74, wherein the TPMS 10 monitors for an incoming request (i.e., an NMRQ request discussed above) for a targeted message. Such a request could be issued from one or more of the plurality of message requesters 30 of FIG. 1. In step 76, a determination is made as to whether an incoming request has been received by the TPMS 10. If a negative determination is made, step 76 is repeated so that incoming requests can be monitored for. If a positive determination is made, step 78 occurs, wherein the incoming request is received at the web server 16 (see FIG. 1) of the TPMS 10.

In step 80, the notification database 14 (see FIG. 1) of the TPMS 10 is queried using the pre-defined criteria information in the received NMRQ request to locate a record in the notification database 14 corresponding to a matching targeted message. The query could be based on a single pre-defined critera, or multiple pre-defined criteria, and could be specified in a suitable query language, such as Structured Query Language (SQL). Any desired query conditions could be specified. For example, the query could require that the following conditions must be met:
1. Drug NDC in queried record must match NDC number specified in NMRQ;
2. Values for one of last fill date, first fill date, days of remaining supply, original number of refills authorized, number of refills remaining, patient age, or patient gender must be within minimum and maximum values specified in NMRQ; and
3. If conditions (1) and (2) above are not satisfied, find record having patient diagnosis and/or patient disease state matching diagnosis and/or disease state specified in NMRQ.

In step 82, after querying is complete and a matching record is retrieved from the notification database 14, a response (NMRP) is generated by the TPMS 10 and transmitted to the message requester (i.e., one or more of the message requesters 30 of FIGS. 1-2). As mentioned above, the NMRP could include fields of information which identify a matching targeted message text and/or voice file. When the NMPR is received by the message requester, the targeted message text and/or voice file identified in the NMPR is then accessed by the message requester, and the targeted message contained therein is conveyed to the requester. The message could be downloaded from a location (e.g., a URL) specified in the NMPR, using any suitable transfer protocol such as Secure File Transfer Protocol (SFTP). In step 84, the aforementioned message delivery receipt (NMRP) and confirmation (NMDC) processes are carried out, and the transaction is completed. Steps 74-84 are then repeated so that additional requests for targeted messages can be received and processed. It should be noted that the monitoring steps 64 and 74 described above could be performed using a single web server which automatically responds to incoming requests, in real time.

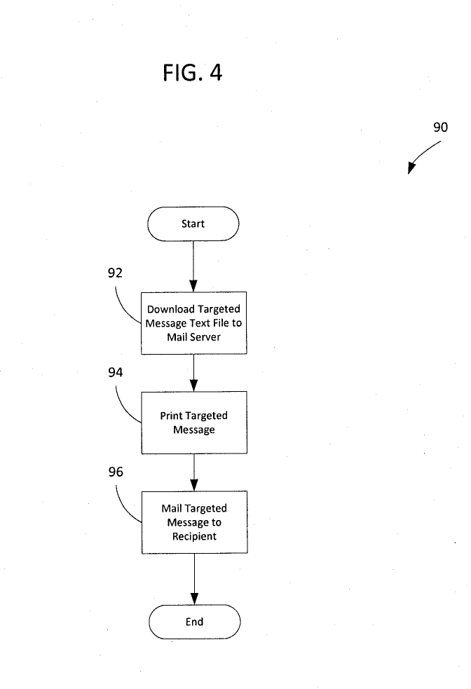

FIG. 4 is a flowchart, indicated generally at 90, showing steps for mailing a targeted pharmaceutical message generated by the present invention to a recipient. In step 92, an HTTP (SOAP) request for a targeted message (containing one or more of the pre-defined criteria discussed above) is transmitted to the TPMS 10 from a mail server, such as the mail server 34 of FIG. 1, and the request is processed as discussed above with reference to FIG. 2. A text file containing a matching targeted message is then downloaded from the TPMS 10 to the mail server. In step 94, the text file is printed using a local or networked printer, such as the printer 36 of FIG. 1. It should be noted that the text file could be edited or formatted as desired prior to printing. In step 96, the printed targeted message is then mailed to a recipient, such as a pharmacy customer, doctor's office, etc. The recipient could be provided with the ability to “opt-in” to one or more selected targeted messaging campaigns, which could be encouraged through monetary incentives.

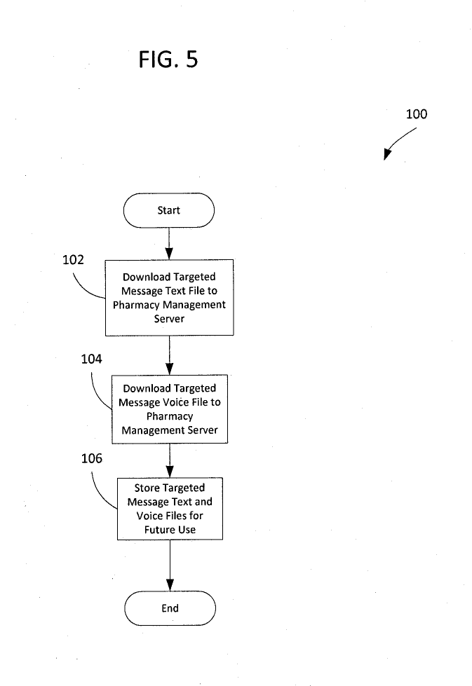

FIG. 5 is a flowchart, indicated generally at 100, showing steps for providing a targeted healthcare message generated by the present invention to a pharmacy management computer system. Such a system could include, for example, any commercially-available computer software and associated hardware utilized to manage pharmacy records, transactions, supplies, business records, etc. In step 102, an HTTP request for a targeted message (containing one or more of the pre-defined criteria discussed above) is transmitted to the TPMS 10 from a pharmacy management computer system, such as the system 38 of FIG. 1, and the request is processed as discussed above with reference to FIG. 2. A text file containing a matching targeted message is downloaded from the TPMS 10 to the pharmacy management computer system. In step 104, a targeted message voice file is downloaded to the pharmacy management computer system. In step 106, the targeted message text and voice files are preferably transmitted whenever prescription-related activity occurs, i.e., in real time. For example, when a pharmacist retrieves a prescription refill request from the pharmacy management computer system, a targeted message could be conveyed to the pharmacist. Optionally, the targeted message text and voice files could be stored in the pharmacy management computer system for future use. The pharmacist could be provided with the ability to “opt-in” to one or more selected targeted messaging campaigns, which could be encouraged through monetary incentives. Such targeted message campaigns could occur in response to future refill activities initiated by the pharmacist, such that targeted messages are automatically conveyed to the pharmacist. If a pharmacist chooses not to participate, he or she can disable targeted messages so that they are not conveyed during refill activities.

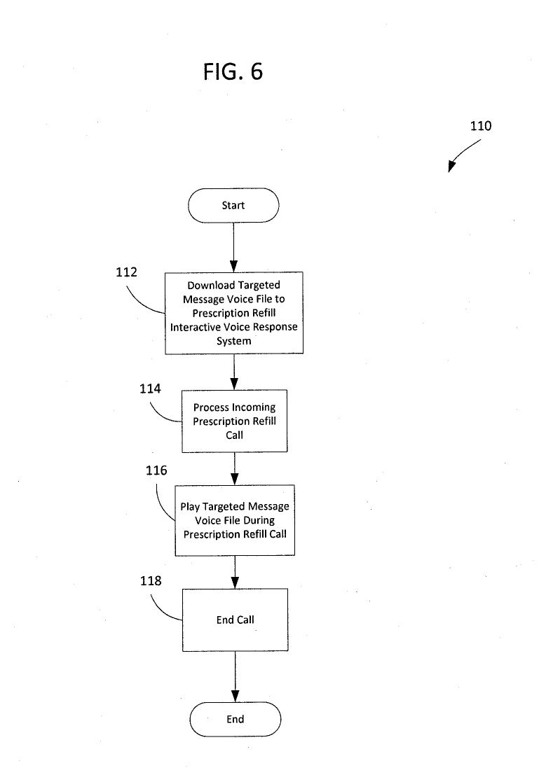

FIG. 6 is a flowchart, indicated generally at 110, showing steps for providing an audible targeted healthcare message generated by the present invention during a telephonic prescription refill request. In step 112, an HTTP request for a targeted message (containing one or more of the pre-defined criteria discussed above) is transmitted to the TPMS 10 from an interactive voice response (IVR) prescription refill system, such as the system 40 of FIG. 1, and the request is processed as discussed above with reference to FIG. 2. A matching targeted voice message file is then downloaded to the IVR prescription refill system. In step 114, an incoming prescription refill telephone call is processed by the IVR prescription refill system. Then, in step 116, during processing of the prescription refill, or shortly thereafter, the downloaded targeted message voice file is played to the caller. In step 118, the call is ended. The caller could be provided with the ability to “opt-in” to one or more selected targeted messaging campaigns, which could be encouraged through monetary incentives. Such targeted message campaigns could occur in response to future calls, such that targeted messages are automatically conveyed to the caller. If a caller chooses not to participate, he or she can disable targeted messages so that they are not conveyed during calls.

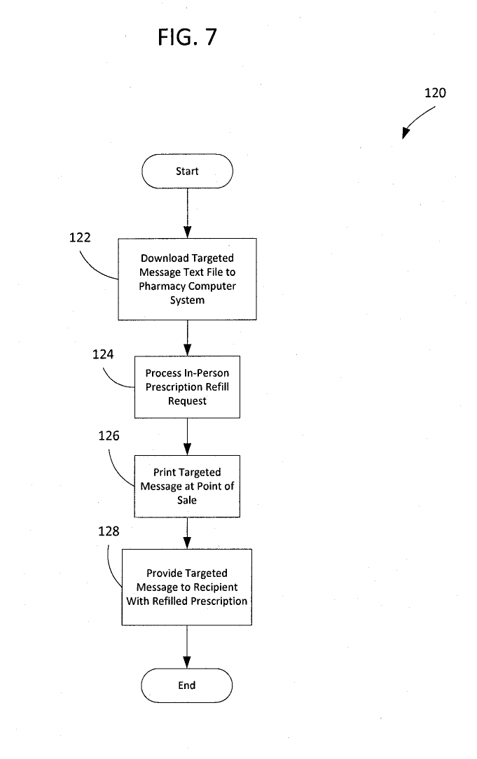

FIG. 7 is a flowchart, indicated generally at 120, showing steps for providing a targeted healthcare message generated by the present invention to a recipient at a pharmacy point of sale.

In step 122, an HTTP request for a targeted message (containing one or more of the pre-defined criteria discussed above) is transmitted to the TPMS 10 from a point-of-sale pharmacy computer system, such as the system 44 of FIG. 1, and the request is processed as discussed above with reference to FIG. 2. A matching targeted message text file is then downloaded to a pharmacy computer system. Targeted messages could be provided in real time, i.e., whenever a prescription-related activity occurs, or they could be downloaded to the pharmacy computer system for future use. In step 124, an in-person (i.e., a customer at a pharmacy) prescription refill request is processed using the pharmacy computer system. In step 126, while the prescription refill request is processed, the targeted message text file is printed (e.g., at the point of sale). Then, in step 128, the printed targeted message is provided to the customer with the refilled prescription. The targeted message could be provided to the customer when the filled prescription is picked up, or when it is delivered to the recipient's home. Pharmacy personnel could be provided with the ability to “opt-in” to one or more selected targeted messaging campaigns, which could be encouraged through monetary incentives. Such targeted message campaigns could occur in response to future refill activities, such that targeted messages are automatically conveyed to the pharmacy personnel. If pharmacy personnel choose not to participate, targeted messages can be disabled so that they are not conveyed in the future.

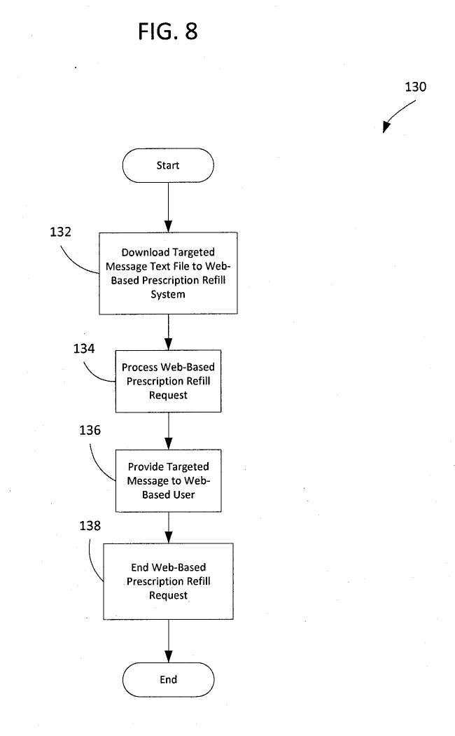

FIG. 8 is a flowchart, indicated generally at 130, showing steps for providing a targeted healthcare message generated by the present invention in a web-based prescription refill request. The web-based prescription refill system allows a user to refill a prescription over the Internet. In step 132, an HTTP request for a targeted message (containing one or more of the pre-defined criteria discussed above) is transmitted to the TPMS 10 from a web-based prescription refill system, such as the system 48 of FIG. 1, and the request is processed as discussed above with reference to FIG. 2. A matching targeted message text file is downloaded to a web-based prescription refill system, such as the system 48 of FIG. 1. In step 134, a prescription refill request is processed by the web-based prescription refill system, and the prescription is refilled. In step 136, the targeted message is provided to the web-based user. The targeted message could be displayed using a conventional web browser. Optionally, a targeted voice or multimedia message could be played to the user. In step 138, the web-based prescription refill request is completed. The web-based user could be provided with the ability to “opt-in” to one or more selected targeted messaging campaigns, which could be encouraged through monetary incentives. Such targeted message campaigns could occur in response to future refill activities initiated by the user, such that targeted messages are automatically conveyed to the user. If a user chooses not to participate, he or she can disable targeted messages so that they are not conveyed in the future.

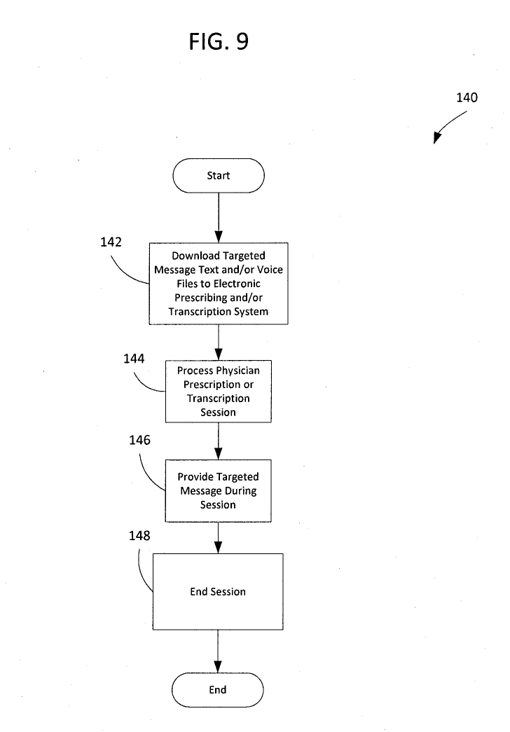

FIG. 9 is a flowchart, indicated generally at 140, showing steps for providing a targeted healthcare message generated by the present invention in an electronic prescription and/or transcription session. Electronic prescription (“e-prescribe”) systems allow physicians to electronically generate prescriptions for patients and to transmit same to a pharmacy. An electronic transcription system provides a central server that receives telephone calls from doctors, allows the doctors to speak a prescription, and automatically transcribes the spoken prescription into text using voice recognition technology. An example of such a system is disclosed in U.S. Pat. No. 6,804,654 to Kobylevsky, et al., the entire disclosure of which is expressly incorporated herein by reference in its entirety.

In step 142, an HTTP request for a targeted message (containing one or more of the pre-defined criteria discussed above) is transmitted to the TPMS 10 from an electronic prescription and/or transcription system, such as the system 50 of FIG. 1, and the request is processed as discussed above with reference to FIG. 2. A matching targeted message text file, and/or a matching targeted message voice file is provided to the physician during the prescription and/or transaction session, i.e., in real time. Optionally, messages could be downloaded to electronic prescription and/or transcription system and stored for future use. In step 144, a prescription and/or transcription session is processed. In step 146, the targeted message is provided to the physician. During an e-prescription session, a targeted message text file could be displayed to the physician on a computer system utilized by the physician during the e-prescription session. Optionally, a voice or multimedia targeted message could be played to the physician. During an electronic transcription session, a targeted message voice file could be played to the physician.

Importantly, physicians could be provided with the ability to “opt-in” to one or more selected targeted messaging campaigns issued by a pharmaceutical company. The decision to opt-in could be encouraged through monetary incentives. Such targeted message campaigns could occur in future prescription or transcription sessions initiated by the physician, such that targeted messages are automatically conveyed to the physician in future sessions. If a physician chooses not to participate, he or she can disable targeted messages so that they are not conveyed during prescription or transcription sessions. In step 148, the prescription and/or transcription session is ended.

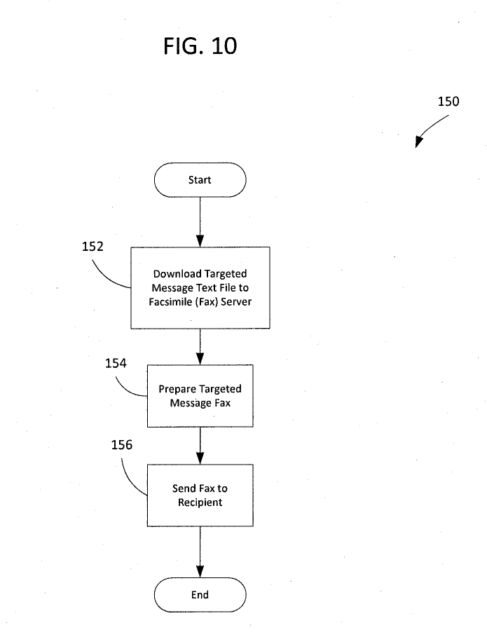

FIG. 10 is a flowchart, indicated generally at 150, showing processing steps for faxing a targeted healthcare message generated by the present invention to a recipient. In step 152, an HTTP request for a targeted message (containing one or more of the pre-defined criteria discussed above) is transmitted to the TPMS 10 from a fax server, such as the fax server 54 of FIG. 1, and the request is processed as discussed above with reference to FIG. 2. A text file containing a matching targeted message is then downloaded from the TPMS 10 to the fax server.

In step 154, a fax containing the targeted message is prepared. In step 156, the fax is then transmitted to a recipient, such as a pharmacy customer, doctor's office, etc. The recipient could be provided with the ability to “opt-in” to one or more selected targeted messaging campaigns, which could be encouraged through monetary incentives.

The present invention could be utilized to deliver targeted healthcare messages to recipients relating to clinical trials. For example, a targeted message requesting whether the recipient wishes to participate in a clinical trial relating to a particular pharmaceutical product could be transmitted to the recipient using any of the forms of communication disclosed herein, (e.g., using the various communications media associated with the TPMS 10 of FIG. 1 and discussed above) when a prescription-related activity occurs. Such a message could be provided to the system of the present invention by a pharmaceutical company conducting a clinical trial, or any other party such as a pharmaceutical marketing firm, a third party organizing and/or conducting clinical trials on behalf of a pharmaceutical company, etc.

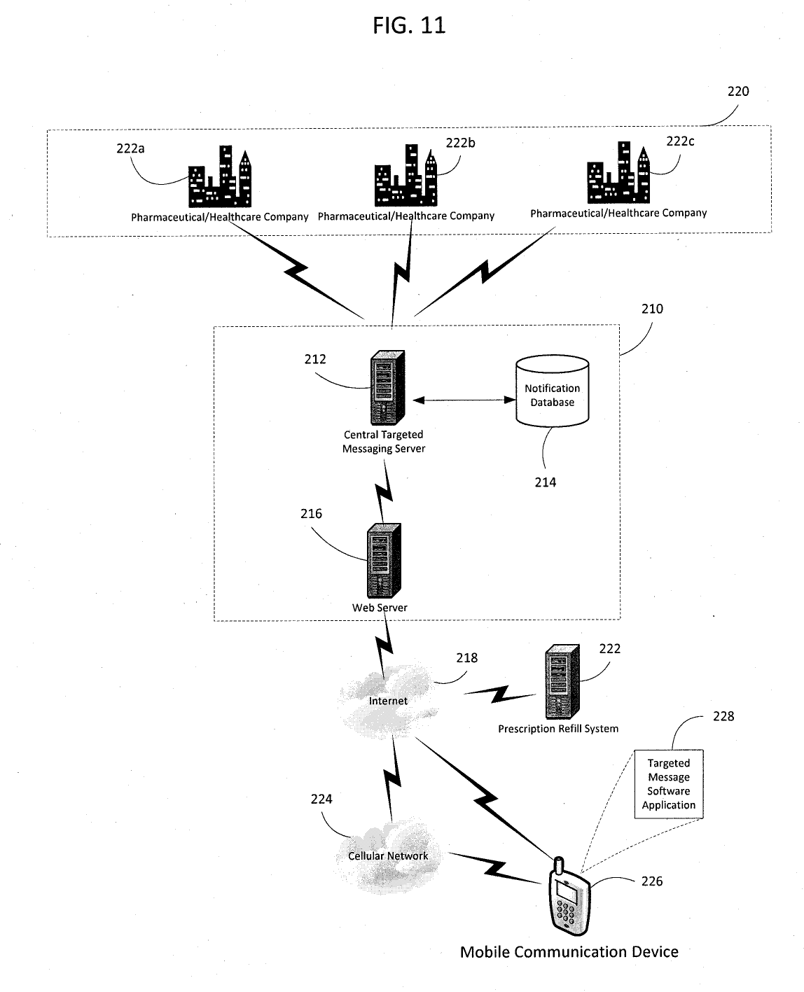

FIG. 11 is a diagram showing another embodiment of the targeted healthcare messaging system 210 of the present invention, wherein targeted healthcare messages are delivered using mobile communications devices. Similar to the embodiments discussed above, the system 210 includes a central targeted messaging server 212, a notification database 214, and an optional web server 216. The targeted messaging server 212 receives targeted healthcare messages from one or more data sources 220 remote from the system 210 and in communication therewith via a network (e.g., the Internet), and assigns pre-defined criteria to the healthcare messages. The data sources 220 could include one or more pharmaceutical and/or healthcare companies 222a-222c, each of which are in communication with the system 210. The pre-defined criteria discussed above could also be utilized in conjunction with the targeted messages uploaded to the system 210 by the data sources 220. Also, it is noted that the processing steps discussed above in connection with FIG. 2 above for handling incoming targeted messages could also carried out by the system 210 to process incoming targeted messages provided by the data sources 220. Further, it is noted that the web server 216 could provide a convenient, web-based user interface for allowing the data sources 220 to create and/or upload targeted messages, assign one or more pre-defined criteria to the messages, and to manage (e.g., edit, delete, add) targeted messages. The targeted messages are stored by the server 212 in a notification database 214, and could take various forms, e.g., they could be textual, video, audio, etc.

The system 210 communicates with one or more mobile communication devices, such as mobile device 226, to deliver targeted healthcare messages to users of such devices. The mobile device 226 could include a cellular phone, a smart phone (e.g., an APPLE IPHONE, a BLACKBERRY smart phone, a smart phone running the ANDROID operating system, etc.), a tablet computer (e.g., an APPLE IPAD, etc.), or other type of communications device. The mobile device 226 communicate with the system 210 via the Internet 218 and/or a cellular (wires) network 224 using one or more wired or wireless communications protocols (e.g., WiFi, WiMAX, 3G, 4G, LTE, etc.). Thus, for example, the mobile device 226 could communicate with the system 210 using an internal cellular transceiver and/or WiFi transceiver within the device 226.

As will be discussed in greater detail below, the mobile device 226 could include a targeted message software application 228 installed locally on the mobile device 226, which receives targeted messages from the system 210 and conveys same to a user of the mobile device 226. The application 228 could be programmed to automatically detect prescription-related activity occurring at the mobile device 22. For example, whenever a user of the mobile device 226 refills a prescription using the mobile device 22 (e.g., to communicate with a remote prescription refill system 222 to refill a prescription), the application 228 could detect such activity, automatically contact the system 210 to obtain a targeted healthcare message from the system 210 relating to a prescription and/or a clinical study or other type of healthcare event associated with the prescription, and convey same to the user of the mobile device 226. The application 228 could be downloaded to the mobile communication device 226 and installed by the user.

It is noted that the application 228 need not be provided in order for the system 210 to provide targeted messages to the mobile communication device 226. In such circumstances, the mobile communication device 226 could deliver targeted messages to the user using a web browser installed and executing on the mobile communication device 226. Thus, for example, if a user of the device 226 accesses a website in order to remotely refill a prescription (e.g., by contacting the remote prescription refill system 222 via the web), the system 222 could automatically contact the system 210 to obtain a targeted message relating to the prescription, and the message could be transmitted to the mobile communication device 226 for subsequently conveying the message to the user of the device 226.

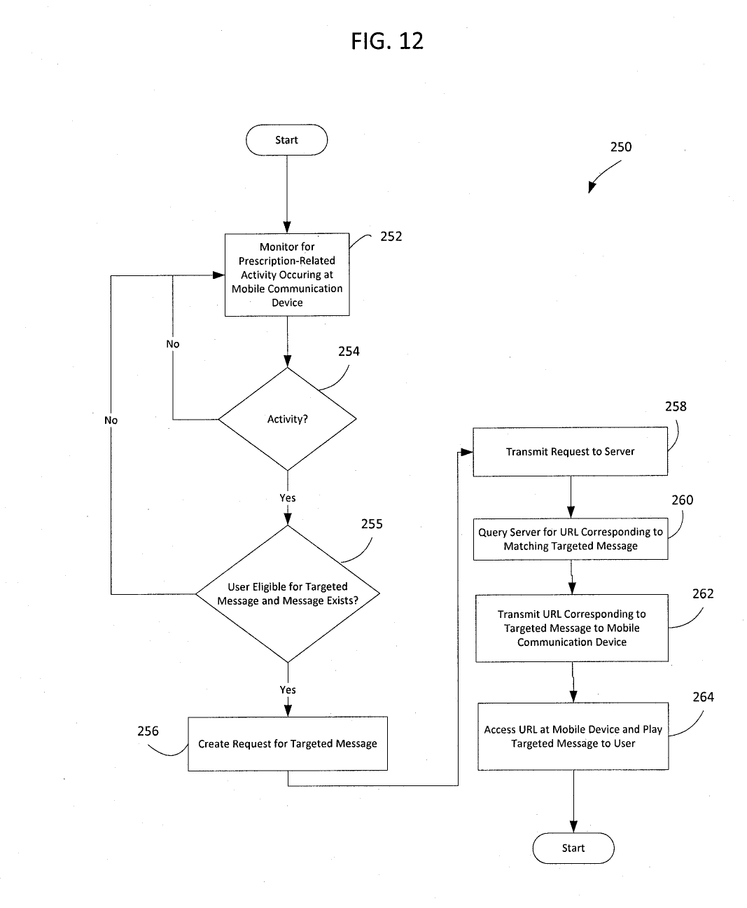

FIG. 12 is a flowchart showing processing steps, indicated generally at 250, carried out by the system 210 of FIG. 11 for delivering targeted messages to mobile communications devices, e.g., to the device 226 of FIG. 11. Beginning in step 252, the present invention monitors for prescription-related activity occurring at the mobile communication device 226. Such monitoring could be carried out by the software application 228 (if installed on the mobile device 226), and/or by a system being accessed by the mobile communication device 226, such as the remote prescription refill system 222 (e.g., when a user of the device 226 refills a prescription remotely using the refill system 222). In step 254, a determination is made as to whether a prescription-related activity has been detected. If no activity has been detected, step 252 is repeated. Otherwise, if a prescription-related activity has been detected, step 255 occurs.

In step 255, a determination is made as to whether the user is eligible to receive a targeted message, and whether such a message exists and is ready to be delivered to the user. This determination can be made by targeted messaging application by way of one or more pre-defined rules/criteria that are programmed into the application and/or which are accessed from a remote source by the application (e.g., from a remote server such as the targeted messaging server discussed herein). If a negative determination is made (either because the user is not eligible to receive a targeted message, or because no messages exist or are ready to be delivered), control returns to step 252. Otherwise, step 256 occurs.

In step 256, a request for a targeted message is created. Such a request could be created at the mobile device 226 (e.g., by the application 228 executed by the mobile device 226), or by a system remote from the mobile device 226 (e.g., by the remote prescription refill system 222).

The request could optionally include at least one pre-defined criteria relating to the prescription-related activity, such as a customer identifier, NDC number, last fill date, first fill date, days of supply remaining in current prescription, number of original refills authorized, refills remaining, patient age, patient gender, patient diagnosis, patient disease state, and/or other criteria. In step 258, the request is transmitted to the server 212 of the system 210. Then, in step 260, the server 212 is queried for a Uniform Resource Locator (URL) link that corresponds to a matching targeted message. The URL link could correspond to a message that is stored in the notification database 214, or to a message that is stored remotely from the system 210, e.g., on one or more remote servers in communication with the Internet. In step 262, the server 212 transmits the URL link corresponding to the matching targeted message to the mobile device 226. Finally, in step 264, the URL link is accessed at the mobile device (e.g., by way of a web browser) and the message is accessed via the URL link and conveyed to the user. It is noted that the message could be transmitted in its entirety to the device 226 (e.g., as a video file, audio file, text file, etc.), and “played” by the device 226 to the user (e.g., using a locally-installed audio/video media application, such as WINDOWS MEDIA PLAYER, etc.), and/or it could be streamed from the server 212 or from another remote server to the device 226. It is noted that the system could also be programmed to request whether the user of the mobile communication device desires to “opt in” to receive future targeted messages, and if so, to only transmit links to targeted messages if the user indicates that he/she wishes to receive such messages.

Having thus described the invention in detail, it is to be understood that the foregoing description is not intended to limit the spirit or scope thereof. What is desired to be protected is set forth in the following claims.

What is claimed is:

1. A system for targeted healthcare messaging using mobile communication devices, comprising:
a targeted messaging server in communication with a plurality of data sources and a mobile communication device remote from the targeted messaging system;
a database in communication with the targeted messaging system and storing a plurality of targeted healthcare messages; and
a targeted messaging application executed by the mobile communication device, the targeted messaging application detecting an occurrence of a prescription-related activity occurring at the mobile communication device, generating a request for a targeted healthcare message in response to detection of the prescription-related activity, and transmitting the request to the targeted messaging server,
wherein the targeted messaging server receives the request, identifies a link corresponding to a matching targeted message, and transmits the link to the mobile communication device, and the link is accessed by the mobile communication device to convey the matching targeted message to the user.

2. The system of claim 1, wherein the software application is downloadable to the mobile communication device from a central software repository remote from the mobile communication device.

3. The system of claim 1, further comprising a remote prescription refill system remote from the mobile communication device and accessed by the mobile communication device.

4. The system of claim 3, wherein the remote prescription refill system automatically generates a request for a targeted message in response to a prescription refill event.

5. The system of claim 1, further comprising a web server in communication with the targeted messaging server, the web server accessible by the plurality of data sources to upload, edit, or delete targeted messages.

6. The system of claim 1, wherein the mobile communication device comprises a cellular telephone.

7. The system of claim 1, wherein the mobile communication device comprises a smart phone.

8. The system of claim 1, wherein the mobile communication device comprises a tablet computer.

9. A method for targeted healthcare messaging using a mobile communication device, comprising the steps of:
detecting a prescription-related activity occurring at a mobile communication device;
generating a request for a targeted healthcare message at the mobile communication device;
transmitting the request to a targeted messaging server remote from the mobile communication device;
receiving the request at the targeted messaging server;
querying a database to identify a link corresponding to a matching targeted healthcare message;
transmitting the link to the mobile communication device; and
accessing the link at the mobile communication device; and
conveying the targeted healthcare message to the user at the mobile communication device.

10. The method of claim 9, wherein the step of detecting the prescription-related activity further comprises detecting the prescription-related activity using a software application installed on and executed by the mobile communication device.

11. The method of claim 9, wherein the step of detecting the prescription-related activity further comprises detecting the prescription-related activity using a remote prescription refill accessed by the mobile communication device.

12. The method of claim 11, further comprising automatically generating a request for a targeted healthcare message in response to a prescription refill event.

13. The method of claim 9, further comprising providing a web server in communication with the targeted messaging server.

14. The method of claim 13, further comprising allowing a plurality of data sources remote from the web server to upload, edit, or delete targeted healthcare messages using the web server.

15. The method of claim 9, wherein the step of conveying the message to the user of the mobile communication device further comprises playing a video file containing the targeted message to the user using the mobile communication device.

16. The method of claim 9, wherein the step of conveying the message to the user of the mobile communication device further comprises playing an audio file containing the targeted message to the user using the mobile communication device.

17. The method of claim 9, wherein the step of conveying the message to the user of the mobile communication device further comprises displaying text containing the targeted message to the user using the mobile communication device.

18. The method of claim 9, wherein the step of conveying the message to the user of the mobile communication device further comprises streaming an audio/visual message containing the targeted message to a user of the mobile communication device.
